(19) United States
(12) Patent Application Publication
(10) Pub. No.: US 2026/0165526 A1
(43) Pub. Date: Jun. 18, 2026

(54) BREWING UNIT OF A COFFEE MACHINE

(71) Applicant: Melitta Professional Coffee Solutions GmbH & Co. KG, Minden (DE)

(72) Inventors: Bernd BUCHHOLZ, Rahden (DE); Armin HENSEL, Rahden (DE); Dirk MEYER, Porta Westfalica (DE)

(73) Assignee: Melitta Professional Coffee Solutions GmbH & Co. KG, Minden (DE)

(21) Appl. No.: 19/119,803

(22) PCT Filed: Oct. 10, 2023
(86) PCT No.: PCT/EP2023/078026

§ 371 Date: Apr. 10, 2025

(30) Foreign Application Priority Data
Oct. 13, 2022 (DE) 10 2022 126 763.6

(51) Int. Cl. A47J 31/36

(52) U.S. Cl. CPC A47J 31/3614

(57) ABSTRACT

A spindle brewing unit of a piston-driven coffee machine has a brewing-unit slider as a brewing chamber, two piston units as dispersion screen and tamper, and a drive motor and at least one gear mechanism. The brewing unit has a double-spindle arrangement with an outer spindle coupled to an inner spindle via the gear mechanism. The brewing-unit slider is displaceable from a first end position into an intermediate position, then into a second end position and back again. The outer spindle has a movement thread, which engages with an outer-spindle nut arranged in the brewing-unit slider. In the first end position, the movement thread does not engage the outer-spindle nut so that a speed of the brewing-unit slider is zero even if the outer spindle continues rotating. In the second end position, the movement thread remains in engagement with the outer-spindle nut and the drive motor has been switched off.

The invention relates to a brewing unit of a piston-driven coffee machine according to the preamble of claim 1 and to a piston-driven coffee machine having such a brewing unit.

Brewing units of piston-driven coffee machines are known in many embodiments. Inside the brewing unit of a piston-driven coffee machine, coffee powder is ground into a brewing chamber and then pressed into a coffee cake. Water heated under excess pressure is then passed through the cake to extract flavorings from the powder. After a product-specific quantity of water has flowed through, the moistened coffee powder is pressed out and the coffee cake (pomace) is discharged into the pomace container.

There are different drive concepts for moving the necessary relative positions of the tamper, dispersion screen and brewing chamber.

The document EP 2 907 427 B1 describes a non-linear gear section that achieves a compromise between high pressing forces and short travel cycles. To move to the various positions, the functional elements are moved with large gradients. When compacting the coffee powder, the drive motor is reduced with a significantly smaller pitch in order to transmit large forces with the same guide.

Document DE 10 2019 119 103 A1 relates to a brewing unit of a piston-driven coffee machine. The brewing unit is designed as a spindle brewing unit with a brewing-unit slider as brewing chamber, two piston units as dispersion screen and tamper, a drive motor and at least one gear mechanism. The brewing unit has a double-spindle arrangement with an outer spindle and an inner spindle. The brewing-unit slider can be moved from a first end position to an intermediate position, then to a second end position and back to the first end position, wherein the outer spindle has a movement thread which engages with an outer-spindle nut axially fixed in the brewing-unit slider. The movement thread of the outer spindle is out of engagement with the outer-spindle nut in the first end position and in the second end position of the brewing-unit slider and a speed of the brewing-unit slider is zero, even if the outer spindle continues to rotate. A piston-driven coffee machine is indicated.

These embodiments have proven their worth, but there is a constant need for improvements in the course of cost savings on components, functional groups, assembly times and maintenance.

The invention therefore has the object of advantageously further developing a brewing unit of a piston-driven coffee machine in order to create an improved brewing unit and an improved piston-driven coffee machine.

The invention solves this object by a brewing unit having the feature of claim 1 and by a piston-driven coffee machine having the feature of claim 10.

A brewing unit of a piston-driven coffee machine according to the invention, wherein the brewing unit is designed in the form of a spindle brewing unit with a brewing-unit slider as a brewing chamber, two piston units as dispersion screen and tamper, a drive motor and at least one gear mechanism, wherein the brewing unit has a double-spindle arrangement having an outer spindle and an inner spindle, wherein the outer spindle is coupled to the inner spindle via the at least one gear mechanism, wherein the brewing-unit slider can be displaced from a first end position into an intermediate position, then into a second end position and back again into the first end position, wherein the outer spindle has a movement thread which is in engagement with an outer-spindle nut arranged in the brewing-unit slider, is characterized in that the movement thread of the outer spindle is out of engagement with the outer-spindle nut in the first end position of the brewing-unit slider, wherein a speed of the brewing-unit slider is zero, even if the outer spindle continues to rotate, wherein the brewing-unit slider is fixed in the first end position by means of a retaining device, and in that the movement thread of the outer spindle remains in engagement with the outer-spindle nut in the second end position of the brewing-unit slider and the drive motor is switched off.

One advantage of this is that it allows the brewing-unit slider to be brought to a rest position in the respective end position in a simple manner, wherein the outer spindle, driven by the drive motor, continues to drive the inner spindle via the gear mechanism in order to position the inner spindle and thus the dispersion screen. An additional motor is not required.

A piston-driven coffee machine according to the invention has the brewing unit described above, with one advantage being a compact design.

In one embodiment, the brewing-unit slider has a first feed gear mechanism with the outer-spindle nut and the retaining device. This results in an advantageously simple and compact design.

In a further embodiment, it is provided that the outer-spindle nut is arranged with an axial play in a receptacle of the brewing-unit slider, wherein a first end-face/contact side (13d) of the outer-spindle nut is in contact with a first pressure side of the receptacle in the first end position, wherein a second end-face/contact side of the outer-spindle nut and a second pressure side of the receptacle are spaced apart by the play, and wherein the second end-face/contact side of the outer-spindle nut and the second pressure side of the receptacle are in contact and the play is arranged between the first end-face/contact side of the outer-spindle nut and the first pressure side of the receptacle when the movement thread of the outer spindle and the outer-spindle nut are in engagement. One advantage of this embodiment is that a so-called “single-spindle operation” is improved, as this allows the brewing-unit slider to be spindled in without load.

A still further embodiment provides that at least one contact side of the threaded region of the internal thread of the outer-spindle nut is segmented with segments, wherein the segments are arranged at a distance from one another around the internal thread on the circumference of the at least one contact side of the outer-spindle nut, each having a resilient effect and protruding from the respective contact side of the outer-spindle nut. In this way, tilting between the outer-spindle nut and the moving thread of the outer spindle is advantageously avoided during the screw-in process.

In another embodiment, the inner spindle is connected to the adjustable dispersion screen or the adjustable tamper and is coupled to the drive via a second feed gear mechanism, and the tamper or the dispersion screen is arranged in a stationary manner, wherein the adjustable brewing-unit slider is guided in a longitudinally displaceable manner by means of the outer spindle and at least one guide rod, and in that the dispersion screen or the tamper is guided in a longitudinally displaceable manner within the brewing-unit slider, wherein the brewing-unit slider and the dispersion screen or the tamper are adjustable at different speeds in common directions of movement. This results in an advantageously simple and cost-effective design. In addition, very high adjustment speeds can be realized.

In a further embodiment, the dispersion screen is coupled to the brewing-unit slider by means of an activated, controllable driver device when a coupling between the outer spindle and the brewing-unit slider is canceled via the first feed gear mechanism and in the region of a backlash of the outer-spindle nut in relation to the brewing-unit slider in order to transfer the movement of the dispersion screen to the brewing-unit slider. This enables an advantageously simple coupling.

It is also advantageous if the controllable driver device is designed as a controllable tappet device, as this enables a compact design.

In yet another embodiment, the controllable tappet device has a hydraulic, pneumatic or mechanical tappet drive. This provides an advantageously simple drive option.

It is provided in an even further embodiment that the tappet drive is connected to a hydraulic, pneumatic or mechanically activated dispersion screen seal of the dispersion screen. In this way, an advantageously simple control of the tappet drive is realized.

In one embodiment, the retaining device has a permanent magnet, an electrically controllable electromagnet or a mechanical locking mechanism. Permanent magnets and electromagnets are advantageously low-cost, high-quality components, while a mechanical lock offers the advantage of a simple design without the need for electrical installations.

In the following, the invention is described in more detail with reference to the drawings by means of an exemplary embodiment and a variant. The figures serve only to explain the invention in more detail and are not limiting for the invention. Individual features described can also be transferred in themselves to further embodiment variants within the scope of general technical knowledge, wherein:

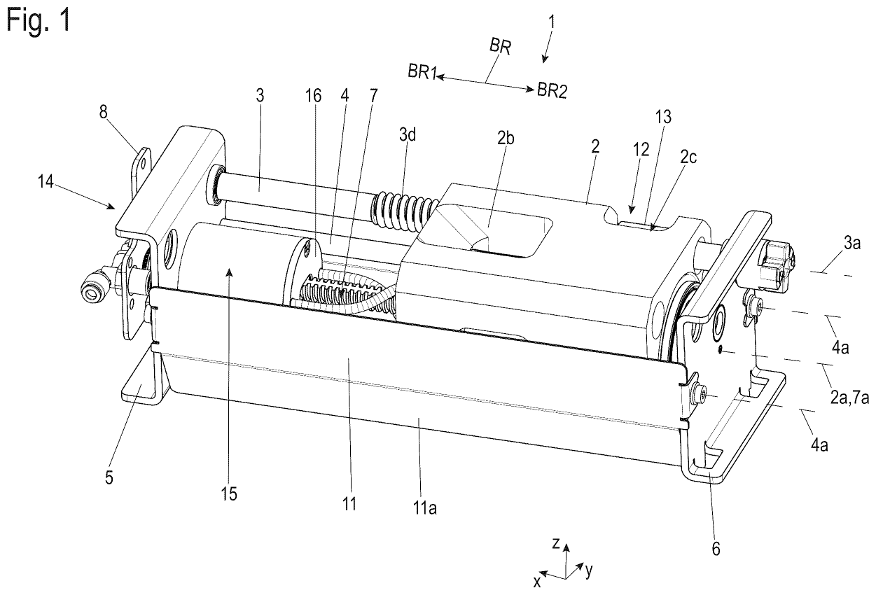

FIG. 1: shows a schematic perspective view of an exemplary embodiment of a brewing unit of a coffee machine according to the invention in a first position;

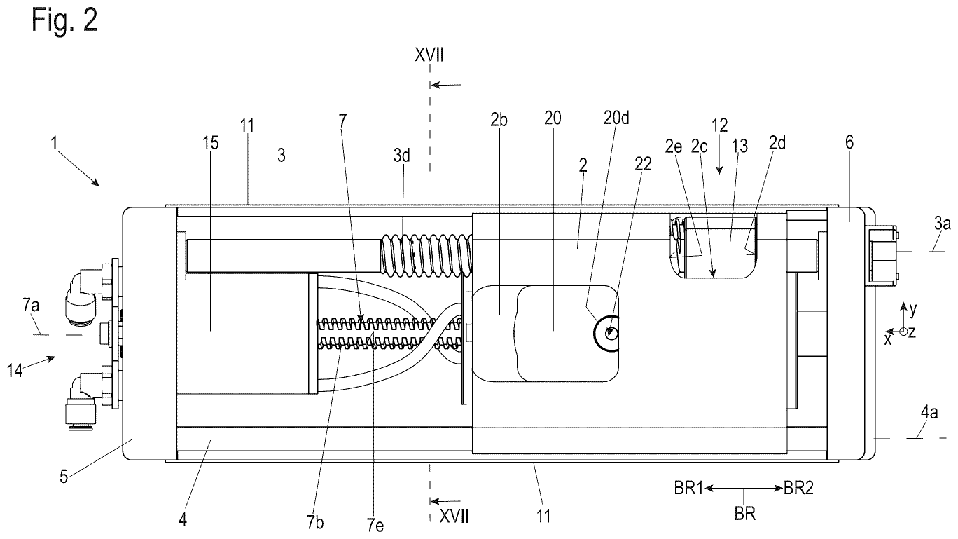

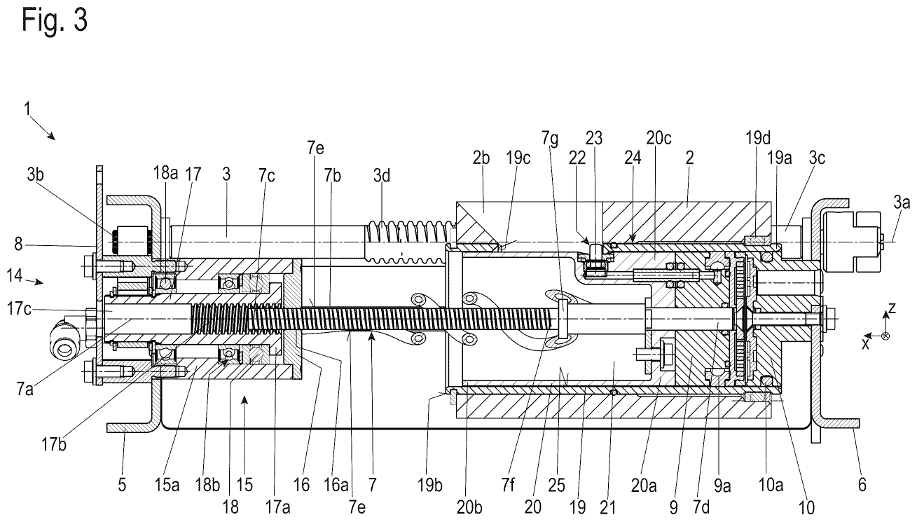

FIGS. 2-3: show various schematic views of the brewing unit according to FIG. 1 in the first position;

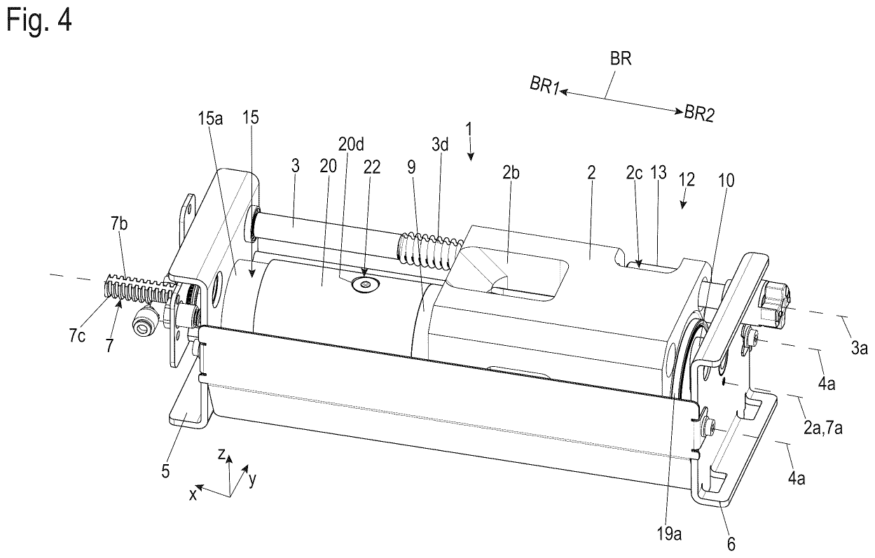

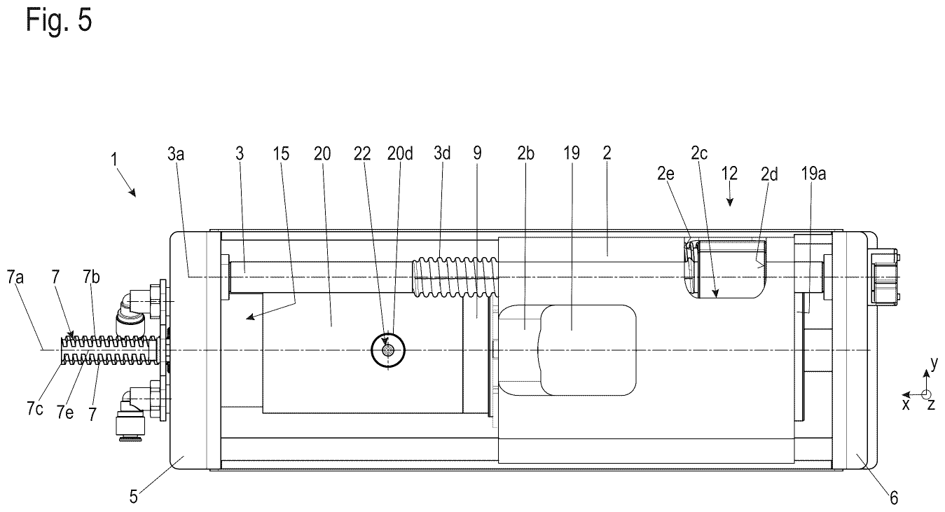

FIGS. 4-6: show various schematic views of the brewing unit shown in FIG. 1 in a second position;

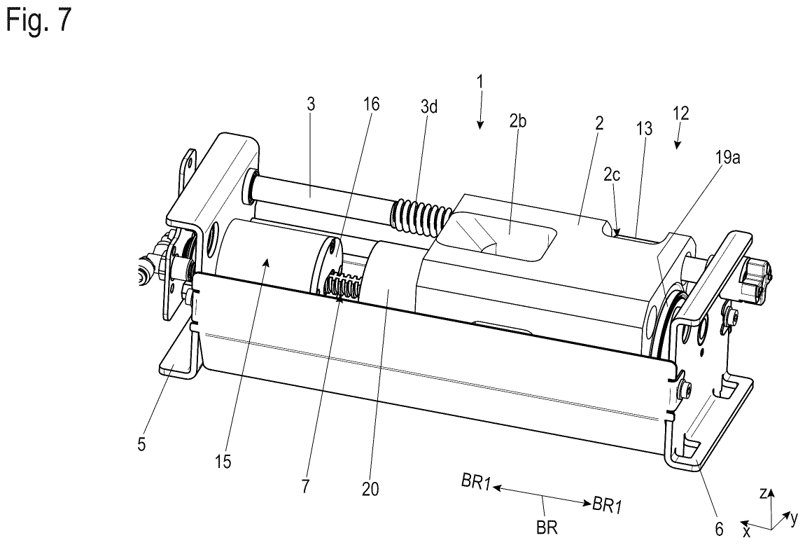

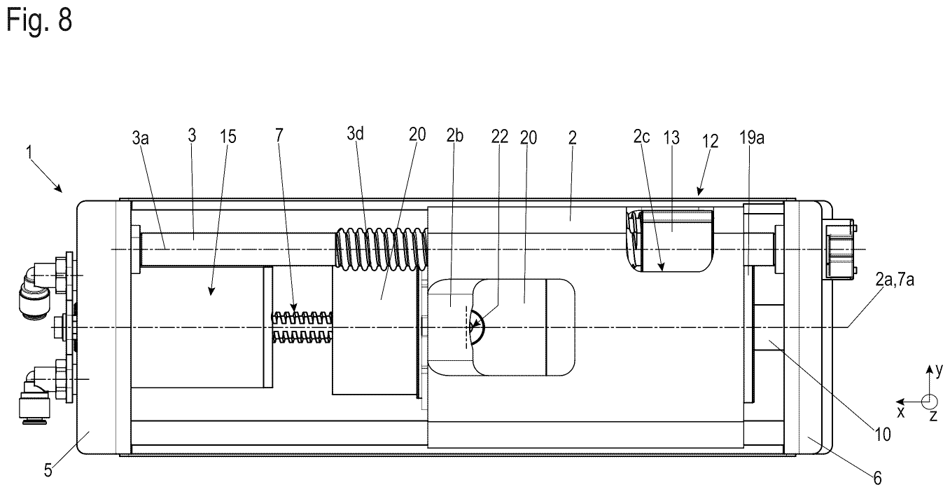

FIGS. 7-9: show various schematic views of the brewing unit shown in FIG. 1 in a third position;

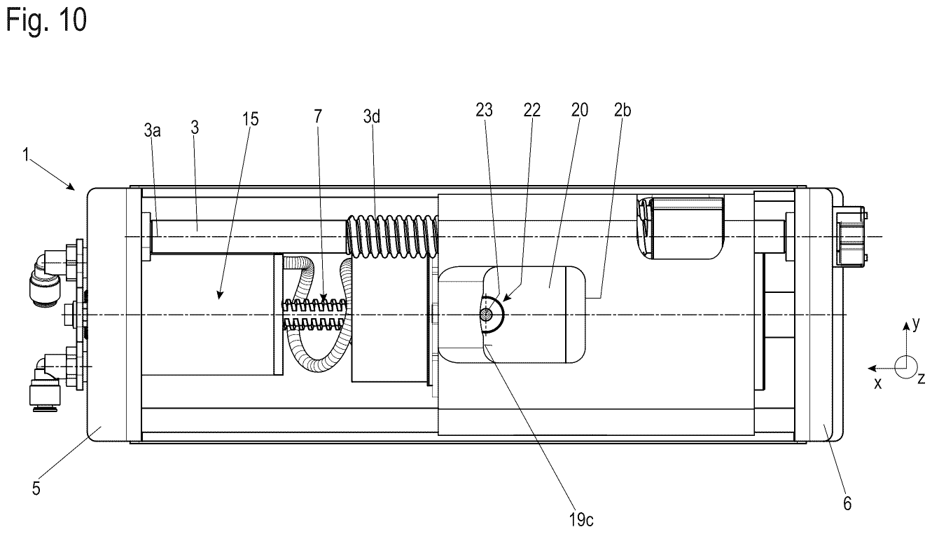

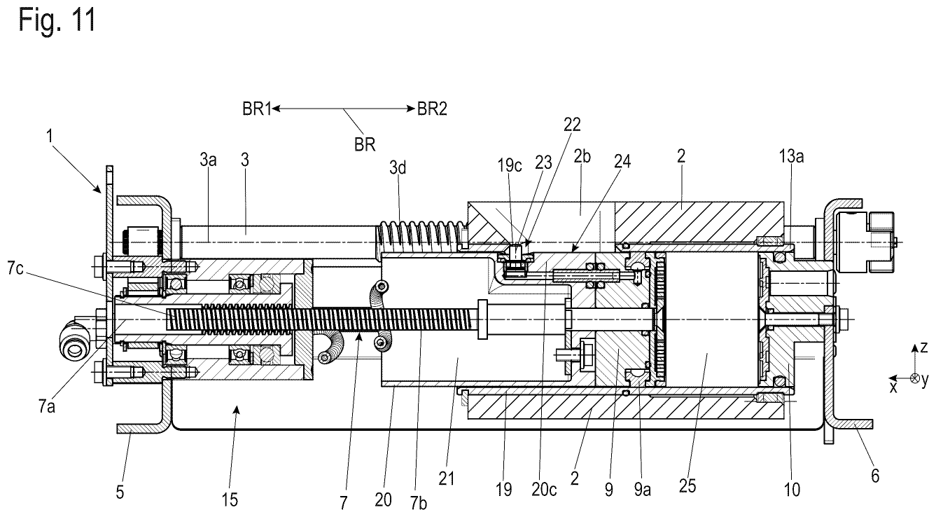

FIGS. 10-11: show various schematic views of the brewing unit shown in FIG. 1 in a driving position;

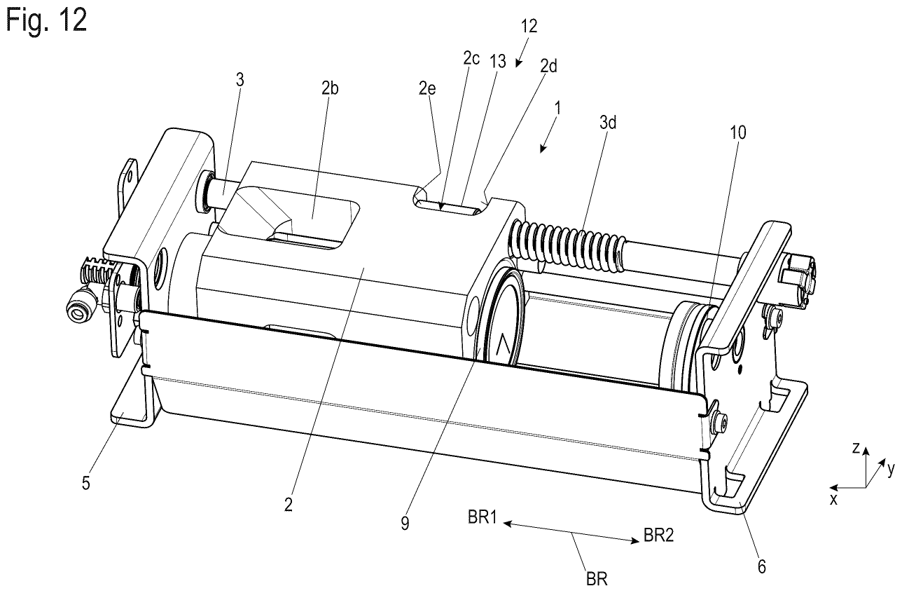

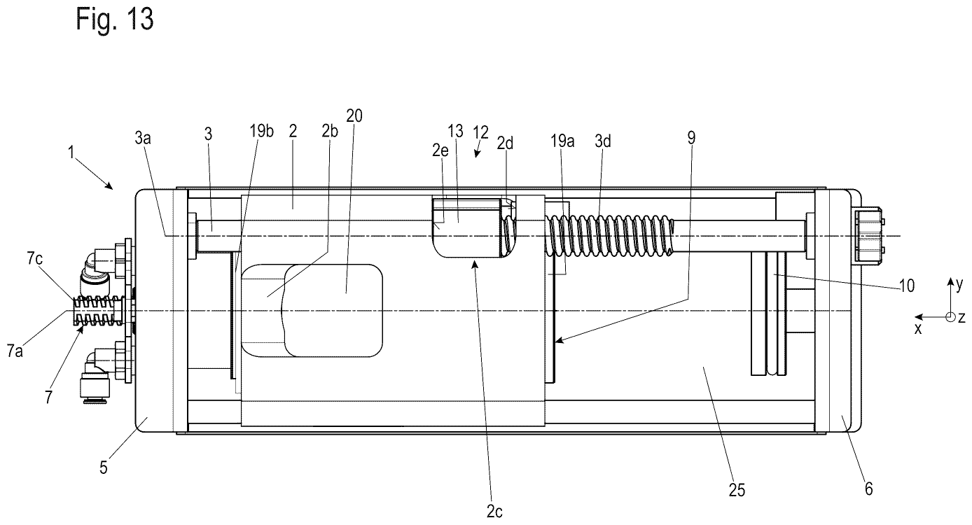

FIGS. 12-14: show various schematic views of the brewing unit shown in FIG. 1 in a fourth position;

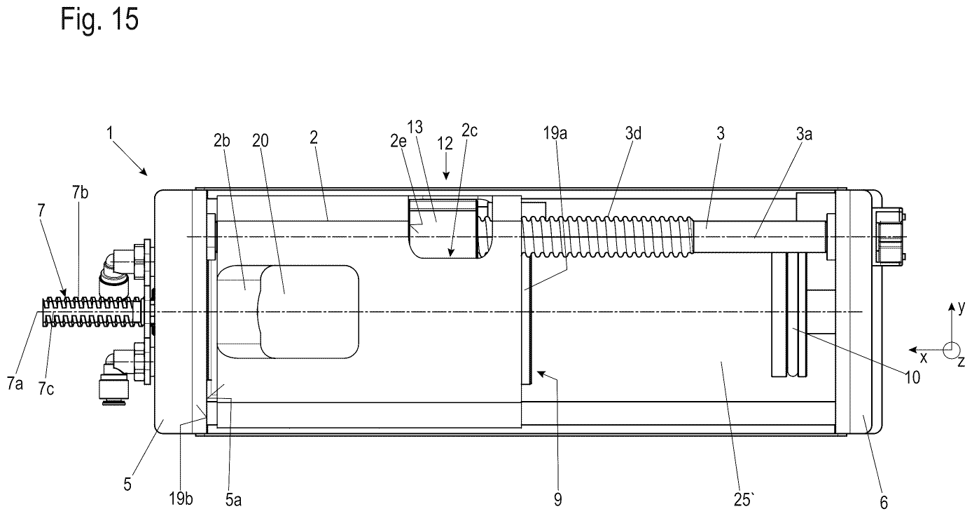

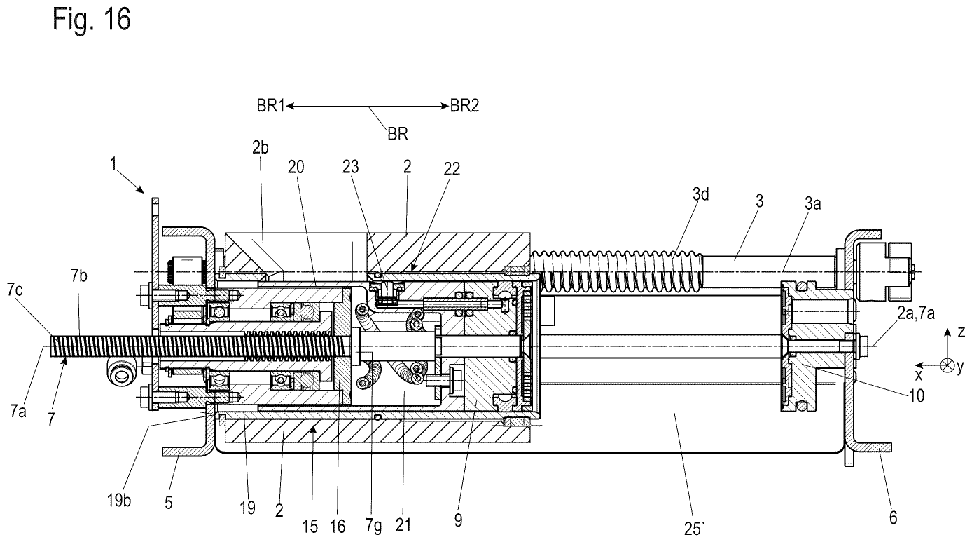

FIGS. 15-16: show various schematic views of the brewing unit shown in FIG. 1 in an end position;

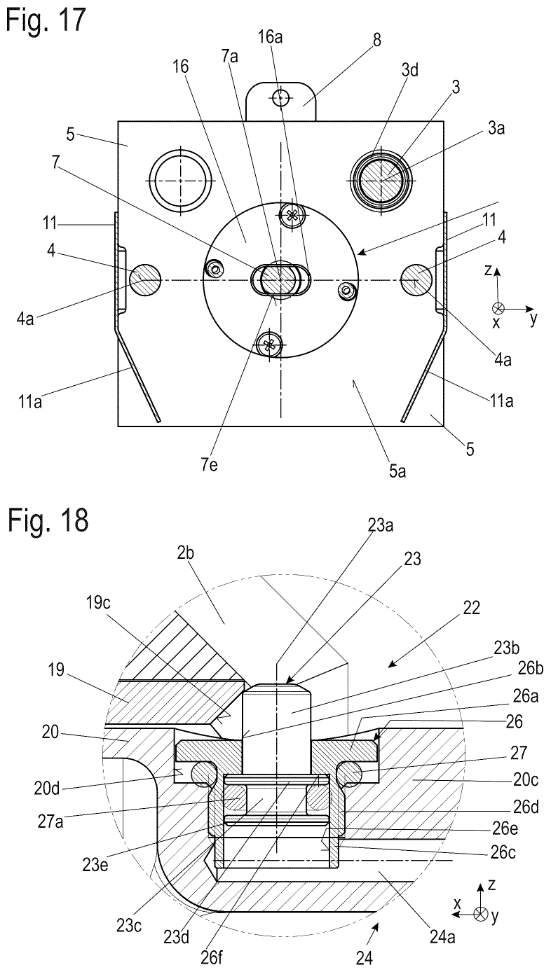

FIG. 17: show a schematic sectional view along line XVII in FIG. 2;

FIG. 18: shows a schematic, enlarged sectional view of a tappet device;

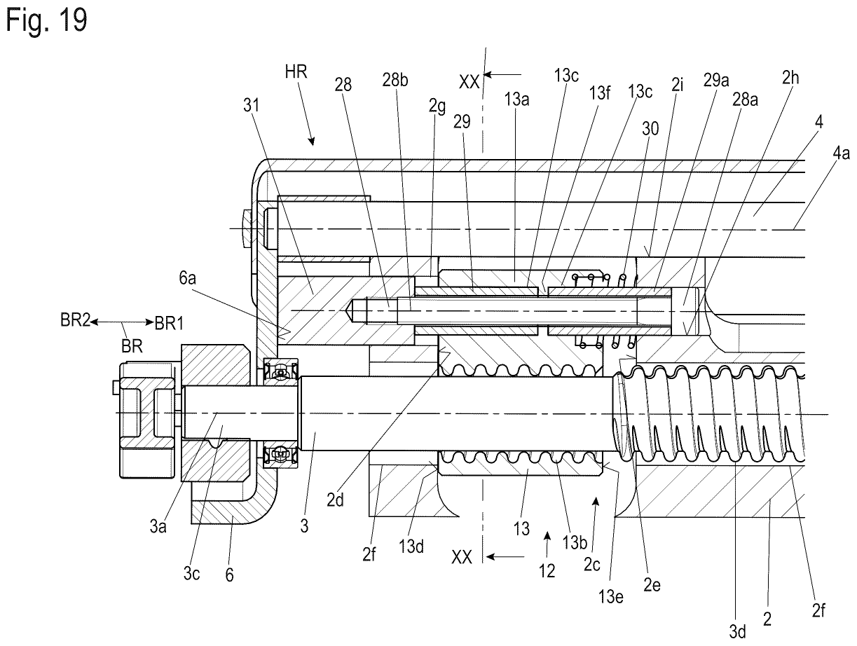

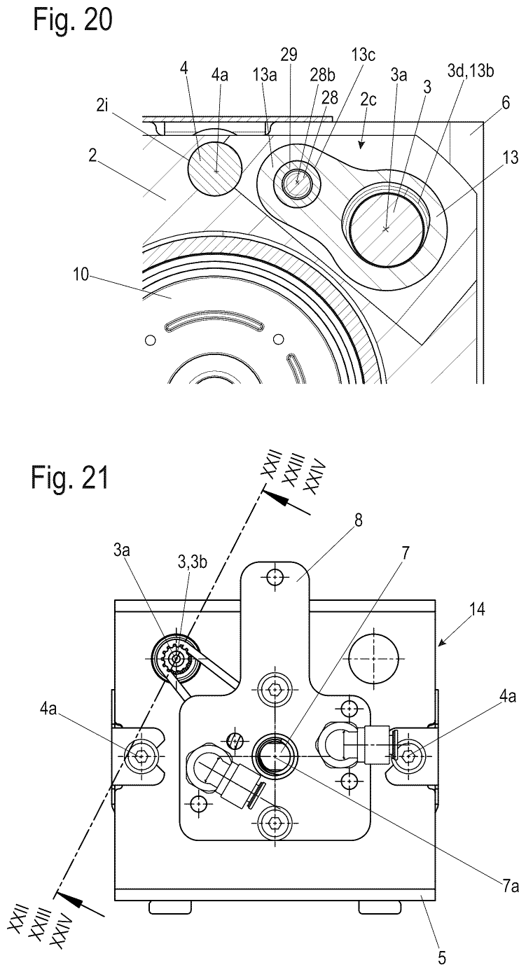

FIGS. 19-20: show schematic sectional views of an outer-spindle nut;

FIG. 21: shows a schematic view of a drive side of the brewing unit according to FIG. 1;

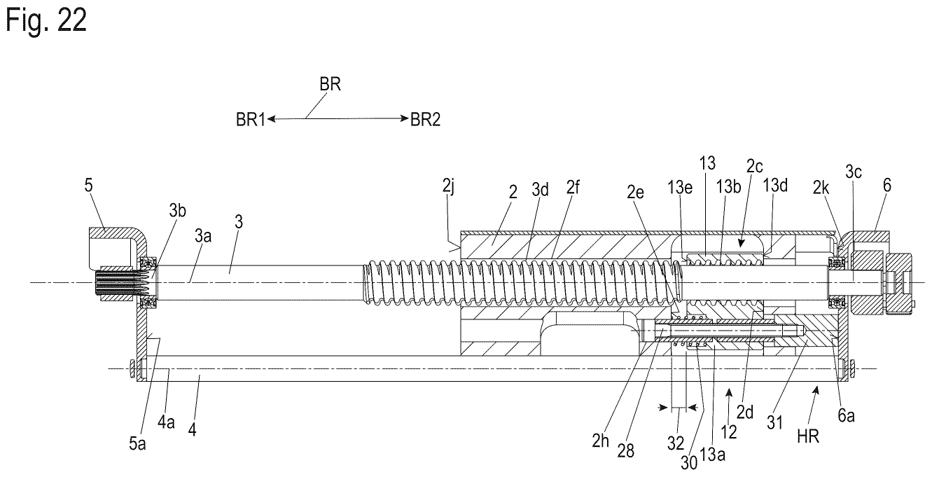

FIGS. 22-24: show schematic sectional views along line XXII-XXIII-XXIV in FIG. 21;

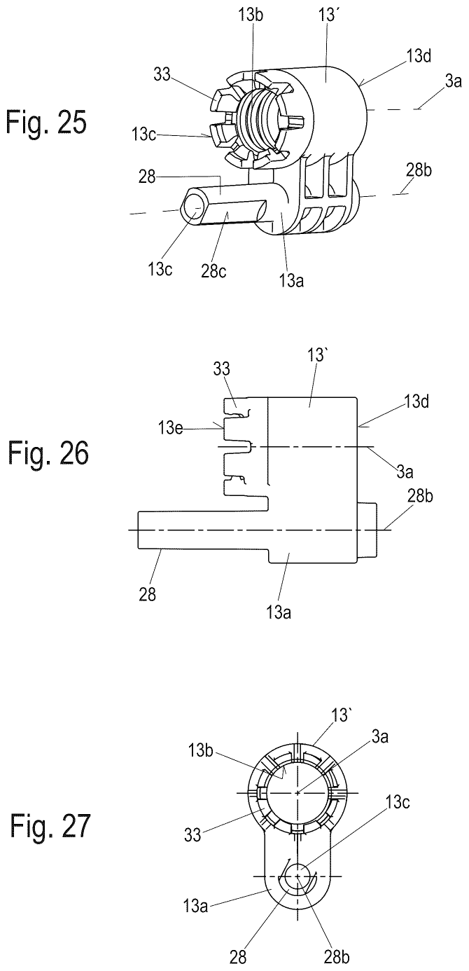

FIGS. 25-27: show schematic views of a variant of the outer-spindle nut;

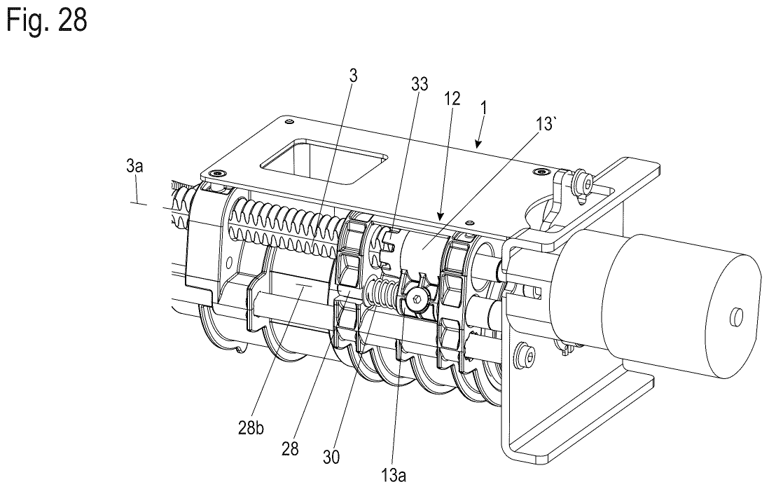

FIG. 28: shows a schematic side view of the brewing unit with the variant of the outer-spindle nut shown in FIGS. 25-27; and

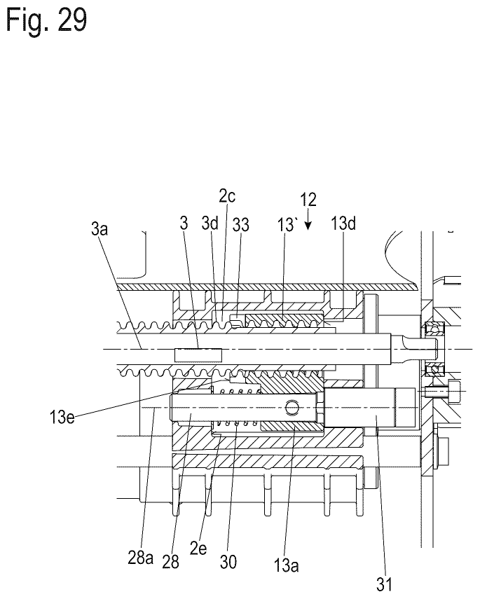

FIG. 29: shows a schematic sectional view of the variant of the outer-spindle nut in the installed state.

Coordinates x, y, z are indicated in the figures for orientation.

FIG. 1 shows a schematic perspective view of an exemplary embodiment of a brewing unit 1 of a piston-driven coffee machine according to the invention. FIG. 2 shows a schematic top view of the upper side of the brewing unit 1 in an x-y plane as shown in FIG. 1. A schematic longitudinal sectional view of the brewing unit 1 according to FIG. 1-2 in an x-z plane is shown in FIG. 3.

The exemplary embodiment shown here is a horizontal brewing unit 1. The embodiment can also be transferred to a vertical brewing unit 1 or one with any other angle of inclination. The brewing unit 1 is a spindle brewing unit.

The brewing unit 1 here comprises a brewing-unit slider 2, which is also referred to as a brewing chamber, an outer spindle 3, at least one guide rod 4 (in the example shown there are two guide rods 4), a first base plate, which is referred to here as a drive plate 5, and a second base plate, which is referred to here as a tamper plate 6, an inner spindle 7, two piston units, namely a so-called dispersion screen 9 and a tamper 10, and at least one drive motor, which is not shown.

The system offers the possibility of realizing the required relative positions between the tamper 10, the dispersion screen 9 and the brewing-unit slider 2 of the brewing unit 1 for a piston-driven coffee machine not shown by means of a double-spindle arrangement and a drive.

The drive motor causes a relative movement between tamper 10 and dispersion screen 9 in the x-direction so that the distance between them can be changed. Defined pressing forces can then be set using various motor torques. At the same time, the brewing-unit slider 2 is moved, making it possible to achieve a filling position for the coffee powder, create a sealed brewing chamber and finally eject the pressed coffee cake.

Here, the dispersion screen 9 and the brewing-unit slider 2 are moved to different positions in the x-direction, wherein the tamper 10 is fixed to the tamper plate 6.

The double-spindle arrangement comprises the outer spindle 3 and the inner spindle 7.

The outer spindle 3 adjusts the brewing-unit slider 2, the inner spindle 7 adjusts the dispersion screen 9.

The outer spindle 3 is coupled to the brewing-unit slider 2 via a first feed gear mechanism 12. This is described in detail below.

In addition, the brewing-unit slider 2 is driven by the dispersion screen 9 by means of a driving device to overcome a so-called backlash. The controllable driver device is designed as a controllable tappet device 22 and is explained in more detail below.

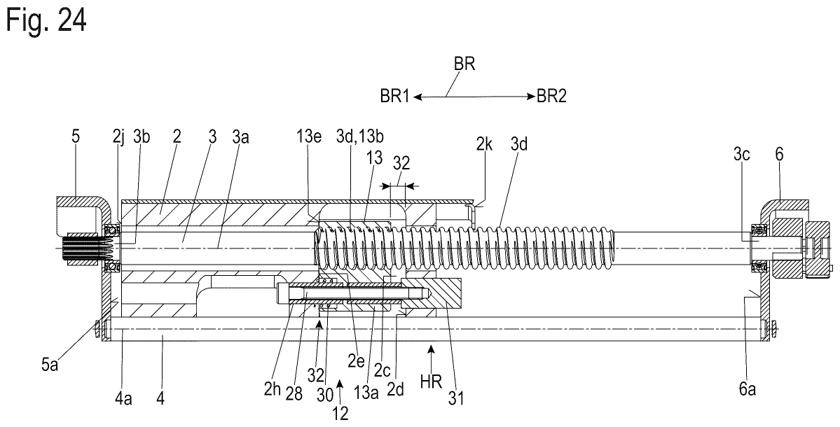

Within this backlash, which has a specific dimension in the x-direction (see play 32 in FIG. 24), the brewing-unit slider 2 is out of engagement with the outer spindle. A coupling between the outer spindle 3 and the brewing-unit slider 2 is canceled by the first feed gear mechanism 12. If this coupling is canceled in the first end position and in the area of the backlash, the brewing-unit slider 2 is coupled to the dispersion screen 9 via the tappet device 22 in order to transfer the movement of the dispersion screen 9 to the brewing-unit slider 2 if there is no coupling between the outer spindle 3 and the brewing-unit slider 2. This is explained further below.

The brewing-unit slider 2 is moved from a park position, which is a first end position of the brewing-unit slider 2, to an intermediate position, then to a second end position and back to the first end position. In the process, the dispersion screen 9 is moved to different positions in relation to the brewing-unit slider 2 and the tamper 10.

The parked position of the brewing-unit slider 2 is shown in FIGS. 1-3.

The intermediate position of the brewing-unit slider 2 is also referred to as the grounds ejection position and is shown in FIGS. 12-14.

Finally, FIGS. 15 and 16 show the second end position of the brewing-unit slider 2.

The dispersion screen 9 is always arranged in the brewing-unit slider 2 within a brewing cylinder 20 of the brewing-unit slider 2 and can assume different relative positions to the brewing-unit slider 2. These relative positions are made possible independently of one another by the movements of the dispersion screen 9 due to the inner spindle 7 and by the movements of the brewing-unit slider 2, which can be adjusted by the outer spindle 3.

The tamper 10 can be located outside or inside the brewing-unit slider 2. As the tamper 10 is arranged in a fixed position here, the relative positions/movements of the brewing-unit slider 2 and the dispersion screen 9 to the tamper 10 are made possible by the inner spindle 7 (dispersion screen 9) and the outer spindle 3 (brewing-unit slider 2). It is also conceivable that the tamper 10 can be adjustable.

The dispersion screen 9 (or the tamper 10) and the brewing-unit slider 2 always have a common direction of travel, but have different speeds (differential speeds) in order to achieve the necessary relative positions between these two components.

However, the parking position of the brewing-unit slider 2 is an exception (FIGS. 1-9). In the parked position, the brewing-unit slider 2 is fixed to the tamper plate 6 by means of a retaining device HR (see FIGS. 19 and 22) and is not engaged with the outer spindle. An independent adjustment movement of the dispersion screen 9 in relation to the brewing-unit slider 2 is then possible.

To make it easier to visualize these directions of travel, each figure shows a double arrow indicating the direction of movement BR with two opposite directions of movement BR1 and BR2 along the x-axis.

In this way, the brewing unit 1 can be adjusted to the following positions.

FIGS. 1-3 show a closed position (first position).

A filling position (second position) is shown in FIGS. 4-6.

FIGS. 7-9 show a brewing position (third position).

An entrainment position is shown in FIGS. 10-11.

A grounds ejection position (fourth position), also known as the open position, is shown in FIGS. 12-14.

FIG. 15 and 16 show an end or final position.

These positions are explained in more detail below.

The outer spindle 3 with an outer spindle axis 3a, the guide rods 4 with guide axes 4a and the inner spindle 7 with an inner spindle axis 7a are arranged parallel to each other. The directions of movement BR1 and BR2 run parallel to these axes 3a, 4a, 7a.

The drive plate 5 and the tamper plate 6 of the brewing unit 1 have rectangular plates which are arranged parallel to each other and at right angles to the axes 3a, 4a, 7a.

A further plate 8 is attached to the drive plate 5 arranged on the left in FIG. 1 parallel to the drive plate 5, which forms a holder for a drive motor not shown, which is only indicated by a reference sign drive 14, and a gear mechanism (e.g. toothed belt or/and gearwheels). The gear mechanism, which is not shown, couples the rotary movements of the inner spindle 7 and the outer spindle 3. The plate 8 is shown in FIG. 21 and forms a holder for a housing 15a of a second feed gear mechanism 15 and for media connections not described in more detail.

One drive end 3b of the outer spindle 3 is mounted on the drive plate 5. The other end of the outer spindle is mounted as bearing end 3c on the tamper plate 6. The outer spindle 3 has an external thread as a movement thread 3d, which interacts with the first feed gear mechanism 12 of the brewing-unit slider 2.

The tamper 10 is attached to the tamper plate 6. The tamper 10, the dispersion screen 9, the brewing-unit slider 2 and the inner spindle 7 are arranged coaxially to a brewing-unit slider axis 2a. The brewing-unit slider axis 2a runs along the inner spindle axis 7a.

The outer spindle 3 and the guide rods 4 connect the drive plate 5 and the tamper plate 6 to each other. The guide rods 4 are each covered over their entire length with a side wall 11, 11a on the outside. The underside of the respective side wall 11 is connected or integrally connected to a respective lower side wall 11a. The lower side walls 11a are folded inwards in relation to the respective upper side wall 11.

FIG. 17 shows a schematic sectional view along line XVII in Fig. 2.

The inner spindle 7 is engaged with a second feed gear mechanism 15. The second feed gear mechanism 15 comprises the housing 15a, a cover 16 with an elongated hole 16a (see FIG. 17), an inner spindle nut 17 with an internal thread 17b, and bearings 18, 18a, 18b.

One end of the housing 15a is attached to the drive plate 5 via the plate 8. The other end of the housing 15a is closed with the cover 16. The inner spindle nut 17 with the bearings 18, 18a, 18b is mounted inside the housing 15a. The bearing 18 is an axial bearing and is supported on a collar 17a of the inner spindle 17. The bearings 18a and 18b are designed as radial bearings or deep groove ball bearings.

The collar 17a of the inner spindle nut 17 is located at one end of the inner spindle nut 17 near the cover 16 and points towards the tamper plate 6. The other end of the inner spindle nut 17 extends through the drive plate 5 to the plate 8 and interacts with the outer spindle 3 via the gear mechanism.

The inner spindle nut 17 has a through-hole 17c, which is formed in the part facing the cover 16 with an internal thread 17b, which engages with a spindle end 7c of an external thread (movement thread 7b) of the inner spindle 7. The internal thread 17b of the inner spindle nut 17 and the external thread (movement thread 7b) of the inner spindle 7 correspond to each other.

The inner spindle 7 is also provided with a flattened section 7e on both sides (best seen in FIG. 17), which together with the elongated hole 16a of the cover 16 (see FIG. 17) forms an anti-rotation lock for the inner spindle 7. In this way, the inner spindle 7 is arranged in a twist-proof manner. The inner spindle nut 17 can be rotated about the inner spindle axis 7a by means of the drive 14 and causes a linear movement of the stationary inner spindle 7 and thus of the dispersion screen 9 via the movement thread 7b/17b.

The flattened section 7e can, for example, be attached directly to the external thread 7b of the inner spindle 7 in such a way that the feed and anti-rotation functions are geometrically connected in parallel. Alternatively, the external thread (movement thread 7b) and the flattened section 7e can be arranged one behind the other. This avoids a modification of the external thread (movement thread 7b), but extends the shape of the inner spindle 7 by the maximum stroke of the dispersion screen 9.

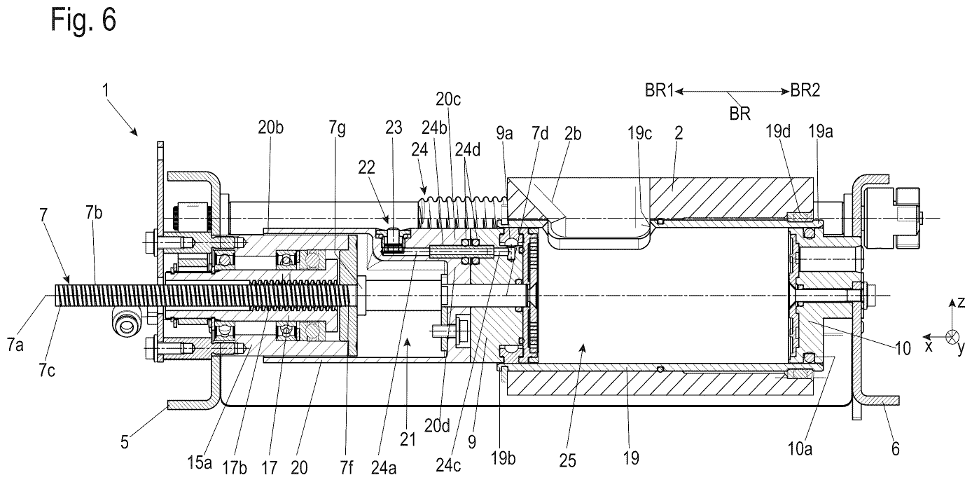

The inner spindle 7 comprises the inner spindle axis 7a, the movement thread 7b, the first spindle end 7c, a second spindle end 7d and the flattened sections 7e. Furthermore, the inner spindle 7 has a thread runout 7f of the movement thread 7b, which faces the tamper plate 6 and is adjacent to a collar 7g. The collar 7g forms a stop in cooperation with the cover 16 and thus an end position of the dispersion screen 9 in the direction of movement BR1 in the direction of the drive plate 5 (see FIG. 6). The spindle end 7c extends through the part of the through-hole 17c without internal thread 17b outwards through the drive plate 5 and an opening of the plate 8 (FIG. 6).

The brewing-unit slider 2 has an essentially hollow cylindrical housing with a circular cross-section and the brewing-unit slider axis 2a. A brewing cylinder 19 with a brewing chamber 25, which also has a circular cross-section, is arranged in the housing coaxially to the brewing-unit slider axis 2a.

The brewing cylinder 19 has a first end face 19a, which faces the tamper plate 6. Opposite, the brewing cylinder 19 is provided with a second end face 19b, which faces the drive plate 5.

An opening 19c is made in the circumferential wall of the brewing cylinder 19, which communicates with a filling opening 2c of the housing of the brewing-unit slider 2. In the area of the first end face 19a of the brewing cylinder 19, a seal 19d is arranged circumferentially in an end area of the housing of the brewing-unit slider 2, which seals the brewing cylinder 19 against the housing of the brewing-unit slider 2.

The brewing chamber 25 of the brewing cylinder 19 of the brewing-unit slider 2 accommodates the dispersion screen 9 and the tamper 10 in certain positions of the brewing unit 1, which are described in detail below. The dispersion screen 9 and the tamper 10 are displaceably guided relative to the brewing cylinder 19 in the brewing chamber 19 in the directions of movement BR1 and BR2. When the dispersion screen 9 and the tamper 10 are both in certain positions of the brewing unit 1 in the brewing chamber 25, they are at different distances from each other.

The brewing-unit slider 2 interacts with the tamper 10 in such a way that the brewing cylinder 19 of the brewing-unit slider 2 is moved over the tamper 10 with the opening belonging to its first end face 19a, wherein the brewing chamber 19 is then sealed with a tamper seal 10a on its side facing the tamper plate 6. The tamper seal 10a is an adjustable seal, e.g. a seal that can be hydraulically activated and deactivated.

The brewing-unit slider 2 is guided by the guide rod 4 between the drive plate 5 and the tamper plate 6 so that it can be moved in both directions BR1 and BR2.

The outer spindle 3 extends through the first feed gear mechanism 12. The feed gear 12 is arranged in a receptacle 2c on an outer side of the brewing-unit slider 2 and has an outer-spindle nut 13 (FIG. 19). The outer-spindle nut 13 is provided with an internal thread 13b, which corresponds to the external thread (movement thread 3d) of the outer spindle 3.

The movement thread 3d of the outer spindle 3 engages with the internal thread 13b of the outer-spindle nut 13, although the movement thread 3d is not engaged with the outer-spindle nut 13 in the rest position (FIGS. 1-11) of the brewing-unit slider 2. This is explained in detail below in connection with FIG. 19 and FIGS. 22-24.

The movement mechanism of the brewing unit 1 is based on two threaded spindle drives, namely the outer spindle 3 and the inner spindle 7. The movement thread 3d of the outer spindle 3 and the movement thread 7b of the inner spindle 7 have different thread pitches.

The outer spindle 3 is synchronized with the inner spindle 7 via the gear mechanism between the drive plate 5 and the plate 8.

The gear mechanism is designed here as a traction gear mechanism with toothed belts (see FIG. 21). It is also possible that the gear mechanism could be constructed with toothed wheels or in combination with toothed belts. The gear mechanism could also be multi-stage.

The outer spindle 3 is, for example, the drive shaft of the brewing unit 1 and ensures a linear movement of the brewing-unit slider 2 via the outer-spindle nut 13 mounted on the brewing-unit slider 2 in its receptacle 2c and secured against rotation.

The coupling by means of the gear mechanism simultaneously ensures a rotary movement of the inner spindle nut 17, which is in engagement with the movement thread 7b of the inner spindle 7. This results in a linear movement of the dispersion screen 9, which is attached to the second spindle end 7d of the inner spindle 7. An anti-rotation lock of the inner spindle 7 via the flattened sections 7e in conjunction with the elongated hole 16a in the cover 16 ensures that the dispersion screen 9 and the inner spindle 7 are not rotated around their own axis (inner spindle axis 7a), but only move axially in the directions of movement BR1, BR2.

The movement thread 7b of the inner spindle 7 has a smaller pitch than the movement thread 3d of the outer spindle 3. For this reason, the speed of movement of the brewing-unit slider 2 is many times greater than that of the dispersion screen 9 with the inner spindle 7. The pitch of the inner spindle 7 is advantageously selected so that it has a self-locking effect during the brewing process.

The dispersion screen 9 and the tamper 10 are arranged in the brewing unit 1 so that their end faces are opposite each other.

The dispersion screen 9 is firmly connected to the inner spindle 7 and has an adjustable dispersion screen seal 9a running around its outside. The dispersion screen seal 9a is an adjustable seal, e.g. a seal that can be hydraulically activated and deactivated.

The dispersion screen 9 and the dispersion screen sleeve 20 can be moved by means of the inner spindle 7 in the brewing chamber 25 and in the brewing chamber 25 of the brewing cylinder 19 in the directions of movement BR1 and BR2. The dispersion screen 9 is inserted into the brewing cylinder 19 through the opening of the brewing cylinder 19 belonging to the second end face 19b.

In addition, a dispersion screen sleeve 20 with a base 20a is attached to the side of the dispersion screen 9 facing the drive plate 5, which extends with an interior 21 over a section of the inner spindle 7 in the direction of the drive plate 5. An end section 20b of the dispersion screen sleeve 20 has an opening to the interior 21, the inside diameter of which corresponds to an outside diameter of the housing 15a of the second feed gear mechanism 15.

The tappet device 22, which has a tappet 23, is arranged on the outside of the dispersion screen sleeve 20. The tappet 23 can be moved in a radial direction from a first position to a second position and back by means of a tappet drive 24. The tappet drive 24 is designed in such a way that the tappet 23 communicates with the hydraulic seal 9a of the dispersion screen via hydraulic lines 24a, 24c (see FIG. 6). In this case, a first line 24a is connected to the tappet device 22 and is arranged in a line section 20c of the base 20a of the dispersion screen sleeve 20, which in this case is molded in. The first line 24a is connected to the second line 24c in the body of the dispersion screen 9 via a line connector 24b. The line connector 24b is sealed via seals 24d both to the base 20a of the dispersion screen sleeve 20 and to the body of the dispersion screen 9.

The second line 24c communicates with the hydraulic dispersion screen seal 9a. screen sleeve 20 or flat with it (FIG. 6).

When the dispersion screen seal 9a is activated, e.g. by an increase in pressure of a hydraulic medium (it can also be compressed air), the tappet 23 is displaced radially outwards from its first position (see FIGS. 6, 9, 14, 16) to its second position (see FIGS. 3 and 11) and protrudes from the outside of the dispersion screen sleeve 20.

In its second position, the tappet 23 protrudes into the opening 19c of the brewing cylinder 19. In this way, a movement of the dispersion screen 9 can be transmitted to the brewing cylinder 19 by means of the inner spindle 7 when the outer-spindle nut 13 is out of engagement with the movement thread 3d of the outer spindle 3.

This is the case when the outer-spindle nut 13 of the brewing cylinder 19 comes out of engagement with the movement thread of the outer spindle 3 during its movement in the direction of movement BR2 towards the tamper plate 6. The tappet 23 of the tappet device 22 is then activated together with the seal 9a of the dispersion screen 9, protrudes into the opening 19c of the brewing cylinder 19, comes into abutment with a wall of the opening 19c facing the tamper plate 6 and transmits the movement of the dispersion screen 9 to the brewing cylinder 2 until the latter or the first end 9a of the brewing cylinder 19 is in its rest position above the tamper 10, wherein an element of the retaining device HR comes to rest against an inside 6a of the tamper plate 6 (see FIGS. 19 and 22).

FIG. 18 shows a schematic, enlarged sectional view of the tappet device 22.

The tappet device 22 comprises the tappet 23 with the tappet drive 24, a tappet holder 26 and seals 27, 27a.

The tappet 23 is a cylindrical component with a tappet axis 23, a tappet body 23b, an intermediate section 23c and two collars 23d, 23e. The tappet body 23b is provided with a tapered chamfer at its upper end and is connected at its lower end via the first collar 23d to the intermediate section 23c, the free end of which terminates with the second collar 23e. An outer diameter of the tappet body 23b is slightly larger than an outer diameter of the intermediate section 23c. The outer diameters of the collars 23d, 23e are the same size and larger than the outer diameter of the tappet body 23b.

The tappet holder 26 is circular-cylindrical and has a collar 26a running around its upper end. A through-opening 26b is formed in the center of the collar 26a, the inner diameter of which corresponds to the outer diameter of the tappet body 23b. A hollow cylindrical guide body 26c with a fastening section 26d and an interior 26e adjoins the collar 26a at the bottom. The interior 26e is circular-cylindrical. Its inner diameter corresponds to the outer diameter of the collars 23c, 23d of the tappet 23. The inner space 26e is open at the bottom.

The tappet 23 is inserted into the tappet holder 26 in such a way that the tappet body 23b extends outwards through the through-opening 26b and the collars 23d, 23e are arranged in the interior 26e. The tappet 23 is slidably guided in the tappet holder 26. The tappet 23 and the tappet holder 26 are arranged coaxially to the tappet axis 23a.

The seal 27a, e.g. an O-ring, is arranged between the collars 23d and 23e and seals the tappet 23 against an inner wall of the inner chamber 26e of the tappet holder 26.

The tappet holder 26 with the tappet 23 is arranged in a receptacle 20e of the dispersion screen sleeve 20 with the collar 26a of the tappet holder 26. The seal 27, e.g. an O-ring, is located between an underside of the collar 26a of the tappet holder 26 and a shoulder of the receptacle 20. The tappet holder 26 is screwed here with its fastening section 26d, e.g. with an external thread, into a corresponding internal thread of the receptacle 20.

The bottom side of the receptacle 20 is communicatively connected to the first line 24a of the tappet drive 24, wherein the interior 26e communicates with the first line 24 of the tappet drive 24.

In FIG. 18, the tappet 23 is shown in its second position protruding into the opening 19c of the brewing cylinder 19. In this second position of the tappet 23, the tappet drive 24 is pressurized with hydraulic medium and exerts an upward force (here in the z-direction) on the lower collar 23e of the tappet 23. This force pushes the tappet 23 out upwards and the upper collar 23d of the tappet 23 against the underside of the collar 26a of the tappet holder 26. This limits the second position of the tappet 23.

FIG. 18 shows the upper end of the tappet 23 in contact with a chamfer of the opening 19c of the brewing cylinder 19. The purpose of the chamfer is to push the tappet 23 back into its first position in the tappet holder 26 when the dispersion screen 9 with the dispersion screen sleeve 20 moves in the x-direction towards the drive side. This depressurizes the tappet drive 24. This is necessary when the brewing-unit slider 2 is entrained from the rest position of the brewing-unit slider 2 when the outer-spindle nut 13 of the brewing-unit slider 2 comes back into engagement with the movement thread 3d of the outer spindle 3. The reason for this is that the movement thread 3d of the outer spindle 3 and the movement thread 7b of the inner spindle 7 have different pitches, as already indicated above.

Alternatively, it is conceivable that the tappet 23 could be permanently spring-loaded, resulting in forced entrainment of the brewing-unit slider 2 (single-spindle operation). In principle, there would be three operating states:
1) Tappet 23 engaged (forced entrainment)
2) Tappet 23 spring-loaded (sliding friction within the brewing cylinder 19)
3) Tappet 23 not engaged (e.g. during the pressing and brewing processes)
   Exemplary embodiments of the spring mechanism can be a compression spring or contours integrated directly into the injection molding of a cleaning reservoir, which create a suitable spring force.

In a further alternative, the tappet 23 can be designed as a resilient pressure piece. In contact with the chamfer of the opening 19c of the brewing cylinder 19, a driving force is then transferred from the dispersion screen 9 to the brewing cylinder 19. Consequently, both movements are synchronized for a short time, and finally the outer-spindle nut 13 is screwed into the movement thread 3d of the outer spindle 3. As soon as the brewing cylinder 19 overtakes the dispersion screen 9 due to the advance of the movement thread 3d of the outer spindle 3, the tappet 23 is spring-loaded and then slides along the inner wall of the brewing cylinder 19 until it leaves the interior of the brewing cylinder 19 and is pushed out again into its rest position in the filling opening 2b by the spring force. The challenge with this design is to select low-wear friction partners and contact surfaces that allow a large number of spring deflection cycles. The result is a particularly simple design without complex seals for the hydraulic path 24a, 24b, 24c of the tappet 23.

FIG. 19 is a schematic longitudinal sectional view of the outer-spindle nut 13 of the first feed gear mechanism 12 of the brewing-unit slider 2 and the retaining device HR in the rest position of the brewing-unit slider 2. FIG. 20 is a sectional view along line XX of FIG. 19.

The outer-spindle nut 13 has an 8-shaped cross-section with a retaining section 13a and a threaded section with an internal thread 13b (FIG. 20). The internal thread 13b corresponds to the external thread 3d of the outer spindle 3.

The outer-spindle nut 13 is arranged in the receptacle 2c on an outer side of the brewing-unit slider 2 in an area facing the tamper plate 6 (see also FIGS. 1, 2, 4, 5, 7, 8, 10, 12, 13, 15).

Furthermore, the outer-spindle nut 13 is formed with two opposing coaxial receptacles 13c, which are arranged in the retaining section 13a and belong to the retaining device HR. A central axis of the receptacles 13c runs parallel to the outer spindle axis 3a or the central axis of the internal thread 13b. The two receptacles 13c are separated by a circumferential shoulder 13f. The shoulder 13 has a through-hole.

The outer-spindle nut 13 has end face and contact sides 13d and 13e. The first end-face/contact side 13d faces the tamper plate 6 and a first pressure side 2d of the receptacle 2c. The second end-face/contact side 13e faces the drive plate 5 and a second pressure side 2e of the receptacle 2c.

The outer spindle 3 extends through through-holes 2f of the brewing-unit slider 2 and through the internal thread 13b of the outer-spindle nut 3.

The retaining device HR comprises a guide pin 28, sleeves 29, 29a, a compression spring 30 and a magnetic element 31.

The guide pin 28 is arranged in the sleeves 29, 29a parallel to the outer spindle axis 3a and has a head 28a at its end pointing towards the drive plate 5, the outer diameter of which corresponds to the outer diameter of the sleeve 29a, wherein the longitudinal axis of the guide pin 28 forms a pin axis 28b.

The sleeves 29, 29a are inserted into the receptacles 13c of the retaining section 13a of the outer-spindle nut 13 in such a way that their respective ends arranged in the receptacles 13c rest against the circumferential shoulder 13f. The shoulder 13f forms an axial stop for both sleeves 29, 29a. The guide pin 28 extends through the two sleeves 29, 29a and the through-hole of the circumferential shoulder 13f.

The other ends of the sleeves 29, 29a each project axially out of the receptacles 13c, wherein the sleeve 29 projects towards the tamper plate 6 together with the head 28a of the guide pin 28 into a through-hole 2g of the brewing-unit slider 2. The other sleeve 29a protrudes in the direction of the drive plate 5 into a further through-hole 2h of the brewing-unit slider 2. The inner diameter of the through-hole 2h corresponds to the outer diameter of the sleeve 29a and the outer diameter of the head 28a of the guide pin 28. The through-hole 2h thus forms a displacement guide for the sleeve 29a and the head 28a.

The compression spring 30 is arranged around the sleeve 29a between the retaining section 13a of the outer-spindle nut 13 and the second pressure side 2e of the receptacle 2c of the brewing-unit slider 2. One end of the compression spring 30 is attached to the outer-spindle nut 13, while the other end of the compression spring 30 contacts the second pressure side 2e of the receptacle 2c of the brewing-unit slider 2.

The magnetic element 31 is firmly connected, e.g. screwed, to the end of the guide pin 28 facing the tamper plate 6. The end of the magnetic element 31 pointing towards the outer-spindle nut 13 contacts the end of the sleeve 29 projecting towards the tamper plate 6. The end of the sleeve 29a pointing towards the drive plate 5 contacts the head 28a of the guide pin 28. The sleeves 29 and 29a are clamped together or firmly arranged between the head 28a of the guide pin 28 and the magnetic element 31 and are also axially fixed to the retaining section 13a of the outer-spindle nut 13 by means of the circumferential shoulder 13f.

The magnetic element 31 is cylindrical and slidably guided in the through-hole 2g of the brewing-unit slider 2. An inner diameter of the through-hole 2g corresponds to an outer diameter of the magnetic element 31.

In the rest position of the brewing-unit slider 2 shown in FIG. 19, the internal thread 13b of the outer-spindle nut 13 and the movement thread 3d of the outer spindle 3 are out of engagement. This state is also referred to as the “disengaged state”. The contact side 13d of the outer-spindle nut 13 facing the tamper plate 6 is in contact with the first pressure side 2d of the receptacle 2c of the brewing-unit slider 2.

The magnetic element 31 of the retaining device HR is in contact with the inside 6a of the tamper plate 6, which is made of a magnetically attractable metal, e.g. steel. In this way, the retaining device HR fixes the outer-spindle nut 13 and thus the brewing-unit slider 2 in its rest position. The spring force of the compression spring 30 also acts and presses the outer-spindle nut 13 in the direction of the tamper plate 6 against the first pressure side 2d of the receptacle 2c of the brewing-unit slider 2.

FIG. 20 also shows one of two guide holes 2i for the guide rods 4 of the brewing-unit slider 2.

FIG. 21 shows a schematic view of a drive side of the brewing unit 1 according to FIG. 1 together with sectional lines for the following FIGS. 22 to 24.

FIGS. 22-24 show schematic sectional views along line XXII-XXIII-XXIV in FIG. 21.

FIG. 22 shows the rest position of the brewing-unit slider 2.

The brewing-unit slider 2 has a first end face 2j, which faces the drive plate 5. An opposite, second end face 2k of the brewing-unit slider 2 faces the tamper plate 6 and is in contact with the inside 6a of the tamper plate 4 as a stop when the brewing-unit slider 2 is in the rest position.

In the rest position of the brewing-unit slider 2, the first end face 13d of the outer-spindle nut 13 is in contact with the first pressure side 2d of the receptacle 2c of the brewing-unit slider 2, which faces the tamper plate 6. Between the second end face 13e of the outer-spindle nut 13 facing the drive plate 5 and the associated second pressure side 2e facing the drive plate 5, a gap is formed as play 32. The play 32 is also called “backlash” and is approximately 5 mm in the example shown. This state is also referred to as “backlash open”.

The outer-spindle nut 13 is “spindled out” and in this case about 2 mm away from the thread outlet of the movement thread 3d of the outer spindle 3.

The brewing-unit slider 2 is in the positions shown above in this rest position or its first end position:
Closed position (first position, FIGS. 1-3)
Filling position (second position, FIGS. 4-6)
Brewing position (third position FIGS. 7-9)

In the closed position of the brewing unit 1 (see FIGS. 1-3), the brewing-unit slider 2 is in the rest position and the dispersion screen 9, together with the dispersion screen sleeve 20, is fully retracted into the brewing cylinder 19 of the brewing-unit slider 2. Dispersion screen 9 and tamper 10 are arranged close together or are in contact. The opening 19c of the brewing cylinder 19 under the filling opening 2b is closed by the dispersion screen sleeve 20. The tappet 23 is in its second position and rests against the edge of the opening 19c facing the tamper plate 6.

To move the brewing unit 1 into the filling position, the tappet drive 24 is first deactivated by means of pressure reduction, wherein the seal 9a of the dispersion screen 9 is also deactivated. The dispersion screen 9 and the dispersion screen sleeve 20 connected to it are moved onto the drive plate 5 in the direction of movement BR1 by means of the inner spindle 7. In the process, the tappet 23 is returned to its first position by the chamfer of the opening 19c (see FIG. 18). The dispersion screen 9 is then in the filling position at the end of the brewing cylinder 19 facing the drive plate 5. The dispersion screen sleeve 20 largely surrounds the housing 15a of the second feed gear mechanism 15 with its end section 20b. The opening 19c to the filling opening 2b is free and coffee powder can be filled into the brewing chamber 25 between the dispersion screen 9 and tamper 10 (FIG. 6).

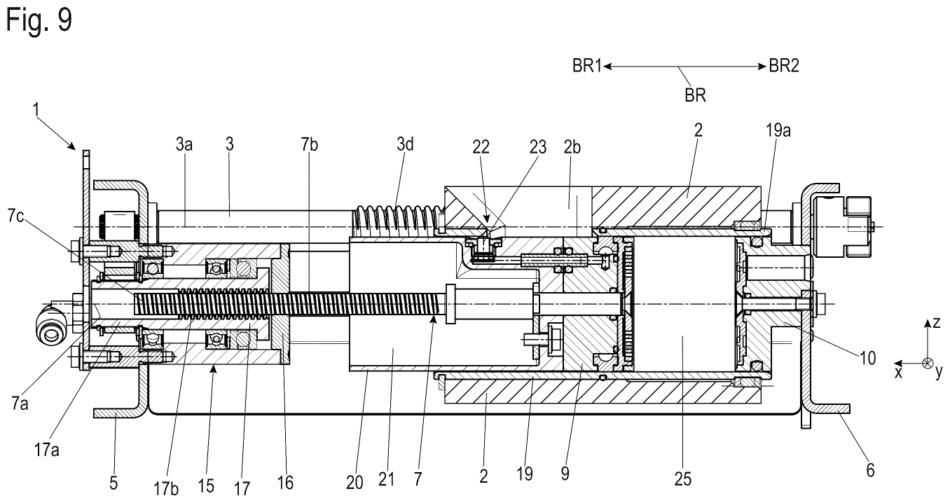

The dispersion screen 9 is then moved back into the brewing cylinder 19 in order to compress the coffee powder in the brewing chamber 25 and assume the brewing position. Further filling of coffee powder and subsequent further compression can be carried out by repeating the approach to the filling position and brewing position (FIG. 9).

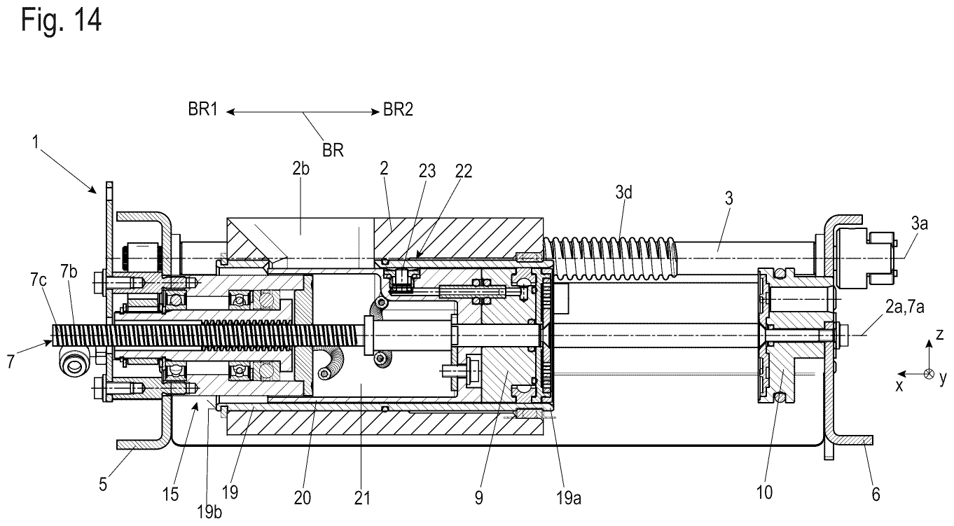

Once the brewing process is complete, the grounds ejection position is assumed. To do this, the entrainment position is reached as shown in FIGS. 10-11 by moving the dispersion screen 9 further into the brewing cylinder 19 in the direction of movement BR2 until the tappet 23 is below the opening 19c of the brewing cylinder 19. The tappet drive 24 is activated, wherein the dispersion screen seal 9a is also pressurized. The inner spindle 7 is then used to move the dispersion screen 9 in the direction of movement BR1 towards the drive plate 5. In its second position, the tappet 23 presses against the edge of the opening 19c of the brewing cylinder 19 and exerts a force in the direction of movement BR1 on the latter and thus on the brewing-unit slider 2. At the same time, this is supported by the friction of the dispersion screen seal 9a in the brewing cylinder 19. The retaining device HR with the magnetic element 31 detaches from the tamper plate 6, the backlash (play 32) is passed through and overcome. The thread 13b of the outer-spindle nut 13 and the movement thread 3d of the outer spindle 3 come into engagement (also referred to as the “single-spindle process”). The compression spring 30 of the retaining device HR is pretensioned, as the second end face 13e of the outer-spindle nut 13, which faces the drive plate 5, is pressed against the associated second pressure side 2e of the receptacle 2c of the brewing-unit slider 2. The adjustment of the brewing-unit slider 2 in the direction of movement BR1 is then taken over by the outer spindle 3 and the tappet 23 is returned to its first position as described above in connection with FIG. 18. By moving the brewing unit 1 further, the grounds ejection position (FIG. 14) is assumed.

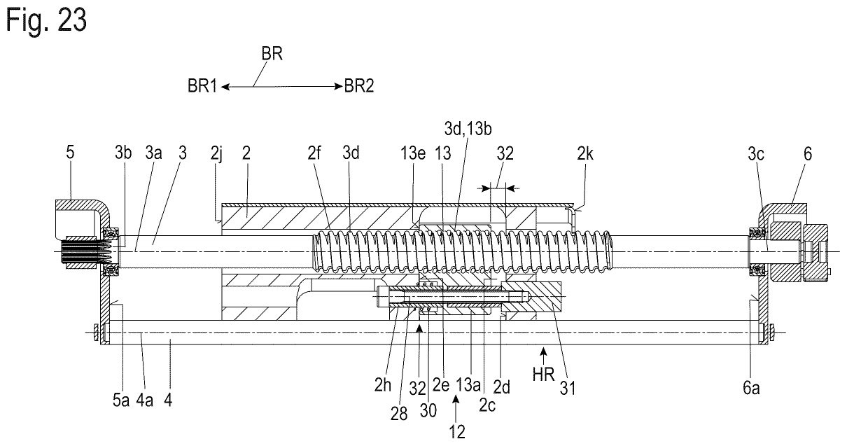

This is also shown in section in FIG. 23. Now the backlash or play 32 is located between the first end face 13d facing the tamper plate 6 and the corresponding first pressure side 2d of the receptacle 2c of the brewing-unit slider 2. This state is also called “backlash closed”.

In the grounds ejection position, the dispersion screen 9 is positioned at the end of the brewing cylinder 19 facing the tamper plate 6, wherein it has pressed out the coffee cake in the brewing chamber 25, which then falls into a collecting container.

The brewing-unit slider 2 is in its intermediate position when the brewing unit 1 is in the grounds ejection position.

By moving the brewing unit 1 further in the direction of movement BR1 towards the drive plate 5, the end position as shown in FIGS. 15-16 and FIG. 24 is assumed.

In the end position of the brewing unit 1, the brewing-unit slider 2 is in its second end position.

In this end position of the brewing unit 1, which is also the end position of the brewing-unit slider 2, the outer-spindle nut 13 and the movement thread 3d of the outer spindle 3 are not spindled out. The collar 7g of the inner spindle 7 forms the end position stop with the cover 16 of the second feed gear mechanism 15. The drive, e.g. electric motor, is switched off by a limit switch (not shown) or a motor current monitor.

This end position serves, for example, as a reference for the positions of the brewing unit 1 and the positions of the brewing-unit slider 2.

To return the brewing-unit slider 2 to the rest position or the first end position from the end position, the brewing unit 1 is moved in the direction of movement BR2 towards the tamper plate 6 until the outer-spindle nut 13 and the movement thread 3d of the outer spindle 3 are spindled out. The tappet 23 is moved to its second position in advance by means of the tappet drive 24. The tappet 23 then rests on the edge of the opening 19c facing the tamper plate 6 and can thus transmit the movement of the dispersion screen 9 in the direction of movement BR2 towards the tamper plate 6, since after the spindling out process the outer spindle 3 no longer transmits any movement to the outer-spindle nut 13 of the brewing-unit slider 2. The brewing-unit slider 2 is thus adjusted to the rest position by means of the movement of the dispersion screen 9 in the direction of movement BR2, wherein the magnetic element 31 of the retaining device HR fixes the brewing-unit slider 2 in the rest position on the inside 6a of the tamper plate 6.

FIG. 25 shows a schematic perspective view of a variant of the outer-spindle nut 13′. A side view is shown in FIG. 26. FIG. 27 shows a front view of a contact side 13e of the variant of the outer-spindle nut 13′. FIG. 28 shows a schematic side view of the brewing unit 1 with the variant of the outer-spindle nut 13′ shown in FIGS. 25-27. FIG. 29 shows a schematic sectional view of the variant of the outer-spindle nut 13′ in the installed state.

The variant of the outer-spindle nut 13′ has some differences to the outer-spindle nut 13 shown in FIG. 19.

In the variant, the guide pin 28 is formed in one piece with the retaining section 13a of the outer-spindle nut 13′, has a flattened portion 28c on one longitudinal side and protrudes from the contact side 13e of the outer-spindle nut 13′.

The compression spring 30 is arranged on the guide pin 28. In the installed state (FIG. 29), one end of the compression spring 30 is supported on the second end-face/contact side 13e of the outer-spindle nut 13′ and the other end is supported on the pressure side 2e of the receptacle 2c of the brewing-unit slider 2 via a disk (not shown).

The second end-face/contact side 13e of the threaded area of the threaded end of the internal thread 13b of the outer-spindle nut 13′ is segmented with segments 33 in order to prevent tilting between the outer-spindle nut 13′ and the moving thread 3d of the outer spindle 3 during the spindling-in process.

The individual segments 33 each have a resilient effect, are arranged at a distance from one another on the circumference of the second end-face/contact side 13e of the outer-spindle nut 13a around the internal thread 13b, i.e. around the threaded end of the internal thread 13, and protrude from the second end-face/contact side 13e of the outer-spindle nut 13′.

As soon as the tip and root diameters of the thread partners (internal thread 13b of the outer-spindle nut 13′ and movement thread 3d of the outer spindle 3) tend to jam, individual segments 33 can spring open, i.e. spring radially outwards. In this exemplary embodiment, eight segments 33 are provided, but a different division may also be appropriate. It is important that an individual segment 33 can spring out when tilted. If spindling out is required at both threaded ends of the outer spindle 3 in the design, segmentation is also conceivable on the contact sides 13d, 13e of both threaded ends of the internal thread 13b of the outer-spindle nut 13.

The invention is not limited by the exemplary embodiment given above, but can be modified within the scope of the claims.

It is conceivable that the movement functionality of dispersion screen 9 and tamper 10 in the brewing unit 1 can also be interchanged, i.e. arranged laterally reversed.

A frame could also be used instead of the drive plate 5 and the tamper plate 6.

The magnetic element 31 can also be a controllable electromagnet. A mechanical locking mechanism in various designs is also conceivable, e.g. a detachable latch.

It is also conceivable that the dispersion screen 9 can be driven by a spring-loaded driving device. For this, it is necessary that the spindle is also spindled out in the second end position. Otherwise, the filling position can no longer be accessed.

### List of reference signs

1 Brewing unit
2 Brewing-unit slider
2a Brewing-unit slider axis
2b Filling opening
2c Receptacle
2d, 2e Pressure side
2g, 2h Through-hole
2i Guide hole
2j, 2k End face
3 Outer spindle
3a Outer spindle axis
3b Drive end
3c Bearing end
3d Movement thread
4 Guide rod
4a Guide axis
5 Drive plate
6 Tamper plate
5a, 6a Inside
7 Inner spindle
7a Inner spindle axis
7b Movement thread
7c, 7d Spindle end
7e Flattened section
7f Thread runout
7g Collar
8 Plate
9 Dispersion screen
9a Dispersion screen seal
10 Tamper
10a Tamper seal
11,11a Side wall
12 First feed gear mechanism
13, 13′ Outer-spindle nut
13b Internal thread
13c Receptacle
13d, 13e Contact side
13f Shoulder
13g Segment
14 Drive
15 Second feed gear mechanism
15a Housing
16 Cover
16a Elongated hole
17 Inner spindle nut
17a Collar
17b Internal thread
17c Through-hole
18, 18a, 18b Bearing
19 Brewing cylinder
19a, 19b End face
19c Opening
19d Seal
20 Dispersion screen sleeve
20a Base
20b End section
20c Line section
20d Receptacle
21 Interior
22 Tappet device
23 Tappet
23a Tappet axis
23b Tappet body
23c Intermediate section
23d, 23e Collar
24 Tappet drive
24a Line
24b Line connector
24c Line
24d Seal
25′ Ejection space
26 Tappet holder
26a Collar
26b Through-opening
26c Guide body
26d Fastening section
26e Interior
27, 27a Seal
28 Guide pin
28a Head
28b Pin axis
28c Flattened portion
29, 29a Sleeve
30 Compression spring
31 Magnetic element
32 Play
33 Segment
BR, BR1, BR2 Direction of movement
HR Retaining device
x, y, z Coordinates

1. A brewing unit (1) of a piston-driven coffee machine, wherein the brewing unit (1) is designed in the form of a spindle brewing unit comprising a brewing-unit slider (2) as a brewing chamber, two piston units as dispersion screen (9) and tamper (10), a drive motor and at least one gear mechanism, wherein the brewing unit (1) has a double-spindle arrangement having an outer spindle (3) and an inner spindle (7), wherein the outer spindle (3) is coupled to the inner spindle (7) via the at least one gear mechanism, wherein the brewing-unit slider (2) is displaceable from a first end position into an intermediate position, then into a second end position and back into the first end position, wherein the outer spindle (3) has a movement thread (3d) which is in engagement with an outer-spindle nut (13) arranged in the brewing-unit slider (2), wherein the movement thread (3d) of the outer spindle (3) is out of engagement with the outer-spindle nut (13) in the first end position of the brewing-unit slider (2), wherein a speed of the brewing-unit slider (2) is zero, even if the outer spindle (3) continues to rotate, wherein the brewing-unit slider (2) is fixed in the first end position by means of a retaining device (HR), and wherein the movement thread (3d) of the outer spindle (3) remains in engagement with the outer-spindle nut (13) in the second end position of the brewing-unit slider (2) and the drive motor is switched off.

2. The brewing unit (1) according to claim 1, wherein the brewing-unit slider (2) has a first feed gear mechanism (12) with the outer-spindle nut (13) and the retaining device (HR).

3. The brewing unit (1) according to claim 2, wherein the outer-spindle nut (13) is arranged with an axial play (32) in a receptacle (2c) of the brewing-unit slider (2), wherein a first end-face/contact side (13d) of the outer-spindle nut (13) is in contact with a first pressure side (2d) of the receptacle (2c) in the first end position, wherein a second end-face/contact side (13e) of the outer-spindle nut (13) and a second pressure side (2e) of the receptacle (2c) are spaced apart by the play (32), and wherein the second end-face/contact side (13e) of the outer-spindle nut (13) and the second pressure side (2e) of the receptacle (2c) are in contact and the play (32) is arranged between the first end-face/contact side (13d) of the outer-spindle nut (13) and the first pressure side (2d) of the receptacle (2c) when the movement thread (3d) of the outer spindle (3) and the outer-spindle nut (13) are in engagement.

4. The brewing unit (1) according to claim 3, wherein at least one contact side (13d, 13e) of the threaded region of the internal thread (13b) of the outer-spindle nut (13′) is segmented with segments (33), wherein the segments (33) are arranged at a distance from one another around the internal thread (13b) on the circumference of the at least one contact side (13d, 13e) of the outer-spindle nut (13a), each having a resilient effect and projecting from the respective contact side (13d, 13e) of the outer-spindle nut (13′).

5. The brewing unit (1) according to claim 1, wherein the inner spindle (7) is connected to the adjustable dispersion screen (9) or the adjustable tamper (10) and is coupled to the drive via a second feed gear mechanism (15), and the tamper (10) or the dispersion screen (9) is arranged in a stationary manner, wherein the adjustable brewing-unit slider (2) is guided in a longitudinally displaceable manner by means of the outer spindle (3) and at least one guide rod (4), and wherein the dispersion screen (9) or the tamper (10) is guided in a longitudinally displaceable manner within the brewing-unit slider (2), wherein the brewing-unit slider (2) and the dispersion screen (9) or the tamper (10) are adjustable at different speeds in common directions of movement (BR1, BR2).

6. The brewing unit (1) according to claim 1, wherein the dispersion screen (9) is coupled to the brewing-unit slider (2) by means of an activated, controllable driver device when a coupling between the outer spindle (3) and the brewing-unit slider (2) is canceled via the first feed gear mechanism (12) and in the region of a backlash of the outer-spindle nut (13) with respect to the brewing-unit slider (2) in order to transfer the movement of the dispersion screen (9) to the brewing-unit slider (2).

7. The brewing unit (1) according to claim 6, wherein the controllable driver device is designed as a controllable tappet device (22).

8. The brewing unit (1) according to claim 7, wherein the controllable tappet device (22) has a hydraulic, pneumatic or mechanical tappet drive (24).

9. The brewing unit (1) according to claim 8, wherein the tappet drive (24) is connected to a hydraulic, pneumatic or mechanically activatable dispersion screen seal (9a) of the dispersion screen (9).

10. The brewing unit (1) according to claim 1, wherein the retaining device (HR) has a permanent magnet, an electrically controllable electromagnet or a mechanical locking mechanism.

11. A piston-driven coffee machine having a brewing unit (1) according to claim 1.
